(19) United States
(12) Patent Application Publication
(10) Pub. No.: US 2004/0000582 A1
(43) Pub. Date: Jan. 1, 2004

(54) Carton lock

(76) Inventor: Robert L. Sutherland, Kennesaw, GA (US)

Correspondence Address: Steve M. McLary, Riverwood International Corporation, Suite 1400, 3350 Riverwood Parkway, SE, Atlanta, GA, 30339, US

(21) Appl. No.: 10/183,935

(22) Filed: Jun. 27, 2002

(51) Int. Cl. B26D 5/42; B65D 65/00

(52) U.S. Cl. 229/103.2; 229/198.2; 206/427

(57) ABSTRACT

This invention relates to a secondary locking system for wrap-around carriers. A secondary male lock is held in the vertical position by a female flap leaning against the male lock. The adjacent pairs of secondary male locks and corresponding female locks are aligned with each other along a single longitudinal line which traverses an adjacent article contained within the carrier.

### BACKGROUND OF THE INVENTION

1. Field of the Invention

This invention relates generally to mechanical locks for holding overlapping flaps of a wrap-around carton in place. More particularly, it is a secondary locking system without a primary lock system.

2. Prior Art

When fabricating a carton from a paperboard blank, opposite ends of the blank are conventionally attached to each other by glue or by a mechanical lock to form the bottom panel of the carton. In the case of a wrap-around carton, flaps located on the ends of the blank typically are overlapped and engaged with one another by mechanical locks formed in the flaps to form the bottom panel of the carton. Since the bottom panel must maintain its integrity throughout the use of the carton, it is essential that the locking system be capable of supporting the weight of the packaged articles, and remain engaged during shipping and handling of the constructed carton.

One approach to provide a stable mechanical lock assembly utilizes both primary and secondary locks. An example of such locking system is disclosed in U.S. Pat. No. 5,443,203 to Sutherland.

### SUMMARY OF THE INVENTION

Briefly described, in a preferred form, it is the object of the present invention to provide a secondary lock system that is more secure and does not become accidentally unlocked resulting in the carrier becoming opened discharging the containers contained therein.

The object of this invention is achieved by providing a secondary lock system. The secondary lock system has a male lock that is inserted into the female opening and held in the vertical position in the carrier by a flap in the female lock system. An arcuate tab on this flap aids in holding the secondary male lock in the vertical position.

Preferably, each secondary male lock is aligned longitudinally to the corresponding female secondary opening to be directly in front of a container contained in the carton. All of the secondary male locks and female openings are longitudinally aligned.

These and other objects, features, and advantages of the present invention will become more apparent upon reading the following specification in conjunction with the accompanying drawing figures.

### BRIEF DESCRIPTION OF THE DRAWINGS

FIG. 1 is a plan view of a blank which incorporates the locking features of the present invention.

FIG. 2 is a perspective view of the bottom of the carton with the secondary locks about to be engaged with the female openings.

FIG. 3 is a perspective view of the bottom of the carton with the locks held in proper position.

FIG. 4 is a perspective view of the carton formed from the blank of FIG. 1 and loaded with containers.

### DETAILED DESCRIPTION OF THE PREFERRED EMBODIMENTS

The present invention is intended primarily for use with wrap-around carriers containing bottles of the type used to contain soft drinks, beer and other types of drinks. It is especially useful for containers that are made of paperboard or plastic and are not as rigid as glass.

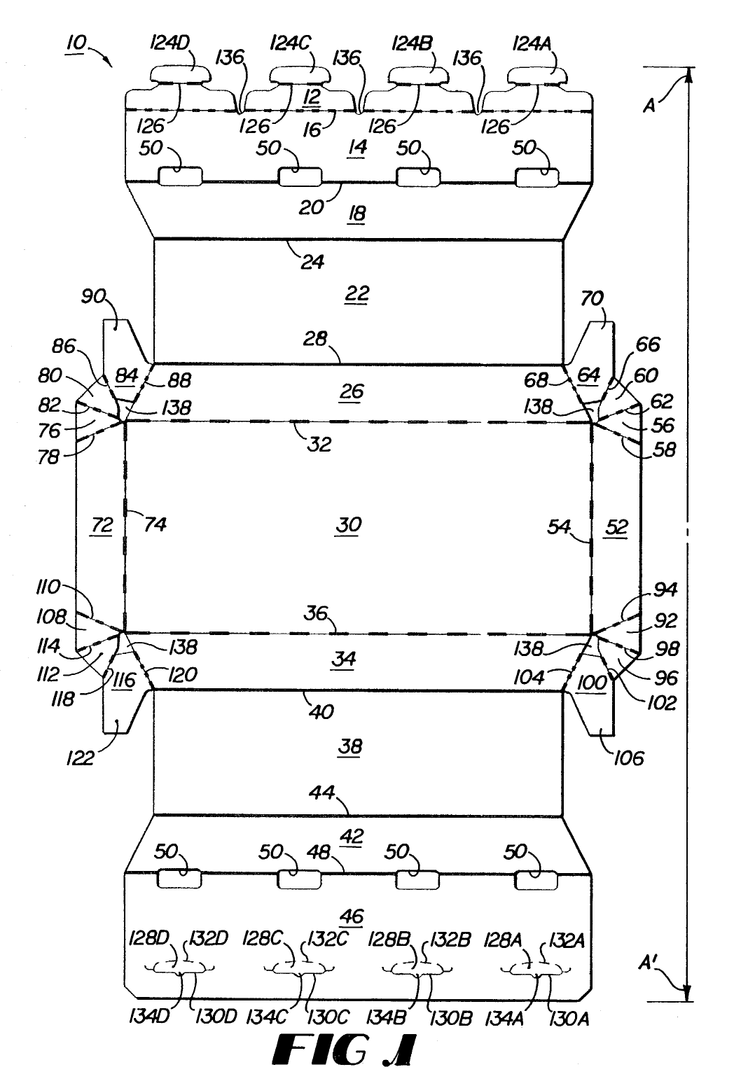

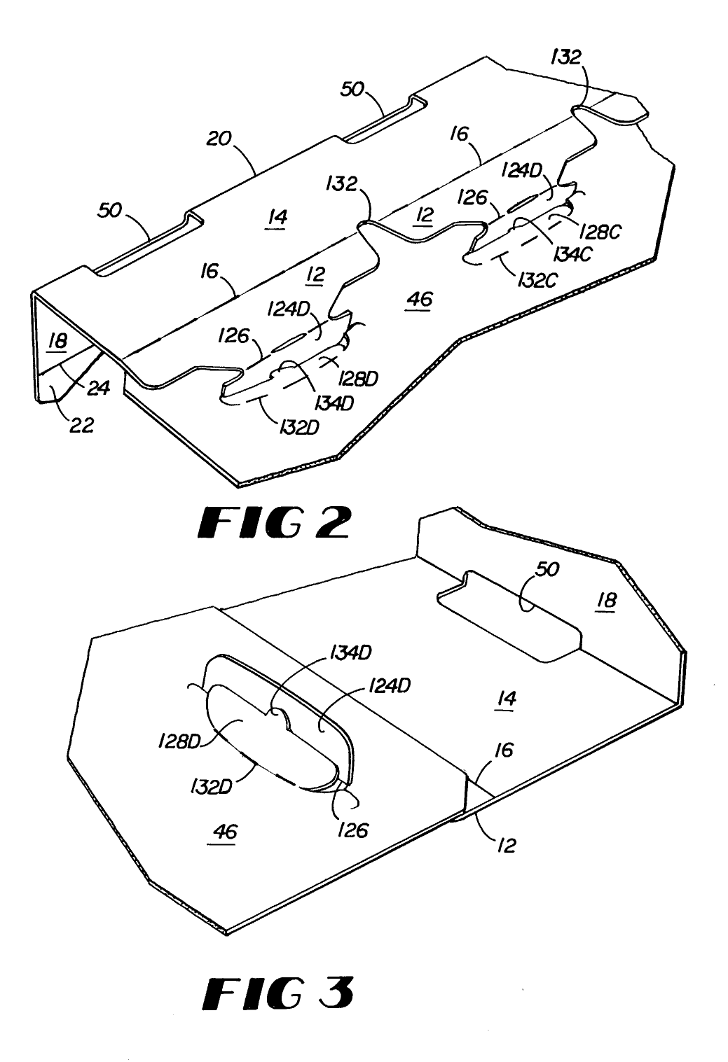

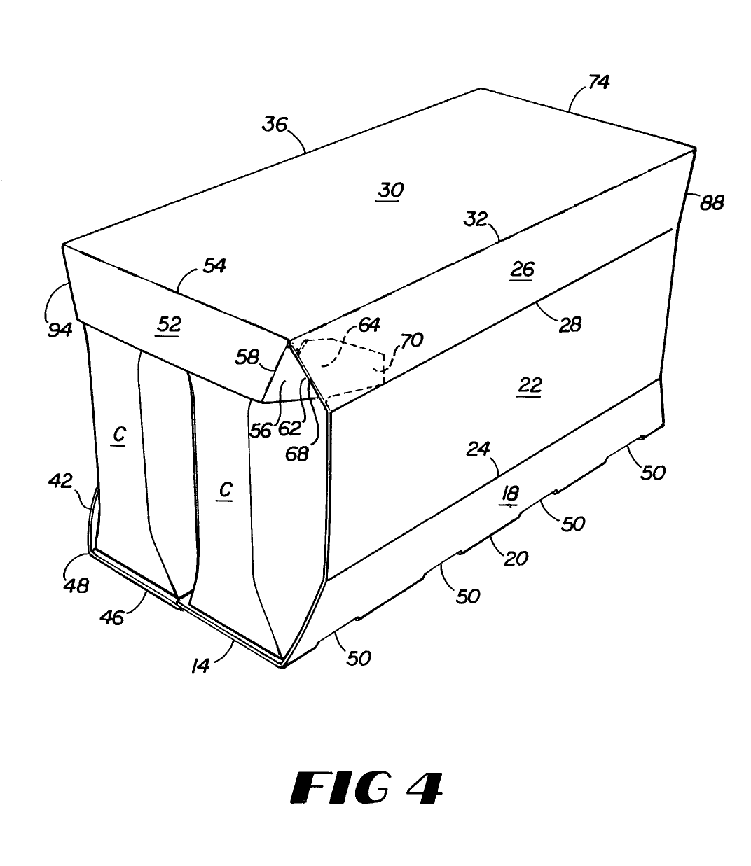

The blank for forming the carrier of this invention is illustrated in FIG. 1. This blank 10 is designed to contain six beverage containers arranged in two rows of three each. The blank 10 is formed from a foldable sheet of material, such as paperboard. The blank has a secondary locking panel 12, which is foldably connected to bottom panel 14 by fold line 16, and in turn connected to lower side panel 18 by fold line 20. Lower side panel 18 is connected to middle side panel 22 by fold line 24, which in turn is connected to upper side panel 26 by fold line 28, and in turn connected to top panel 30 by fold line 32. In a similar fashion, top panel 30 is connected to upper side panel 34 by fold line 36, which in turn is connected to middle panel 38 by fold line 40 and in turn connected to lower side panel 42 by fold line 44. Lower side panel 44 is connected to bottom panel 46 by fold line 48.

This carton 10 has apertures 50 for containing the heels of containers contained therein. The tops of the containers are restrained from falling out of the ends by the top end panels. Top end panel 52 is connected to top panel 30 by fold line 54. Top end panel 52 is connected to triangular gusset panel 56 by fold line 58 which in turn is connected to triangular web panel 60 by fold line 62. Triangular web panel 60 is connected to tuck-in panel 64 by fold line 66, which in turn is connected to upper side panel 26 by fold line 68. Tuck-in panel 64 has a holding flap 70 for holding top end panel 52 in proper position in contact with the end containers in the carton.

In a similar fashion, top end panel 72 is connected to top panel 30 by fold line 74. Tuck-in panel 72 is connected to triangular gusset panel 76 by fold line 78 and in turn connected to triangular web panel 80 by fold line 82 and finally connected to tuck-in panel 84 by fold line 86. Tuck-in panel 84 is connected by fold line 88 to upper side panel 26. Tuck-in panel 84 has a holding flap 90.

Top end panel 52 is connected to triangular gusset panel 92 by fold line 94 and in turn connected to triangular web panel 96 by fold line 98. Triangular web panel 96 is connected to tuck-in panel 100 by fold line 102. Tuck-in panel is connected to upper side panel 34 by fold line 104 and has a holding flap 106. End panel 72 is connected to triangular gusset panel 108 by fold line 110 and in turn connected to triangular web panel 112 by fold line 114. Triangular web panel 112 is connected to tuck-in panel 116 by fold line 118, which in turn is connected to upper side panel 34 by fold line 120. Tuck-in panel 116 has a holding flap 122.

As previously mentioned, this carton is unique in that it has only a secondary locking system. Secondary male locks 124A-D are connected to secondary locking panel by fold line 126. The secondary female locking system is located in bottom inner panel 46 and has secondary female flaps 128A-D formed by cut lines 130A-D. The secondary female flap has a fold line 132A-D for folding the flap into a locked position. The arcuate tabs 134A-D are used for holding the male locks in the locked position.

It will be understood by those in the art that the preferable carrier is symmetrical about a horizontal line of bisection, as viewed from FIG. 1. This symmetry aids in the efficient production of the present carrier. The carrier need not have such symmetry, although it is preferred. As shown, the blank 10 is rectangular in shape and includes straight edges, which also makes for an efficient layout of the blank in a web from which the blanks are cut.

Finger apertures or other types of apertures or straps for carrying the carrier may be provided in the top panel 30.

Unlike conventional locking systems, the carton of this invention does not include both a primary locking system and a secondary locking system. Rather, it has been found that a secondary locking system will satisfactorily hold the carton together. This is especially true if certain conditions are met. The first condition is that each set of secondary male locks and secondary female openings be aligned longitudinally along the center of the container being carried in front of which they are located. The second condition is that each of these containers has a degree of flexibility which allows the container to be somewhat compressed in the locking arrangement which secures the lock in the locked position.

It will be noticed from the drawings that each pair of secondary locking locks are aligned longitudinally, i.e. the length of the blank (A-A′). The secondary male locks 124A-D are aligned longitudinally with cut line 130A-D of the secondary female locks. The longitudinal line that runs through the carrier and through the containers also runs through the corresponding secondary male lock and corresponding secondary female opening.

This invention provides a locking system that is more secure than prior art locking systems. The secondary locks are secured in that the secondary male locks 124A-D are held in the vertical position in respect to the carrier by secondary female flaps 128A-D and arcuate tabs 134A-D illustrated in FIG. 1. If the secondary male locks 124A-D were allowed to be parallel to the secondary locking panel 12, they could easily become disengaged.

The carton of this invention is formed from the blank of FIG. 1 by moving the top panel 30 of the blank over the containers. The blank 10 is pulled tight about the containers and the secondary locking panel 12 is overlapped on bottom panel 46 with the secondary locking panel 12 being on the outside. Slits 136 facilitate locking the locks one at a time. The secondary male locks 124A-D are bent along fold line 126 and are punched in where the enter into primary female openings by cut lines 130A-D. Secondary female flaps 128A-D project inwardly with arcuate tabs 134A-D holding the secondary male locks 124A-D in the vertical position. The secondary male locks 124A-D are held in the vertical position by secondary female flaps 128A-D. The arcuate 130A-D on each secondary female flap lean against the secondary male lock 124A-D and assist in holding the secondary male locks in the vertical position. Holding the secondary male locks 124A-D in the vertical position ensures that the locks are not accidentally withdrawn. It will be noticed from FIG. 1 that the secondary locks are aligned along longitudinal lines parallel to line A-A′ in FIG. 1. Top end panels 52 and 72 are pushed inwardly into the end containers by pushing tuck-in panels 64, 84, 100 and 116 and the respective triangular shaped web panels 60, 80, 96, and 112 and the triangular gusset panel 56, 76, 92 and 108. Holding flaps 70, 90, 106 and 122 hold the top end panels 52 and 72 in proper position with the holding flaps being between the container and the sides of the carton.

While the invention has been disclosed in its preferred forms, it will be apparent to those skilled in the art that many modifications, additions, and deletions can be made therein without departing from the spirit and scope of the invention and its equivalents as set forth in the following claims.

### UNIQUE FEATURES OF THIS INVENTION

The use of a secondary locking system which is aligned longitudinally with the containers being carried is a unique feature of this invention. This is facilitated by the use of containers or articles with flexible side walls. This invention features top end panels that are held in position by a gusset consisting of a triangular web panel, triangular gusset panel, and tuck-in panel and holding flap. This is also believed to be a unique feature.

This invention is particularly useful on containers that have some flexibility such as plastic tubs, PET bottles and composite containers and the like, but it should be understood that the invention is not so limited as it can also be used on glass bottles.

This carrier is designed to be erected on a static feedlock system where there are no moving parts with compression fingers pulling the carrier together by the heel apertures. The carrier is pulled together somewhat beyond what is required for locking and then the locking becomes secure as the compression is relaxed allowing the flexible articles being carried to secure the locks.

Because of the longitudinal arrangement of the locks in relation to the containers, the stress is placed in a longitudinal direction rather that in a diagonal direction which facilitates holding the locks in the locked position. Because of the resiliency of the containers, compression on the heel apertures can overcompensate in locking the locking mechanism which is then slightly loosened after the lock has been set. This can be arranged between the locks so that they can be locked one at a time without putting undue stress on the adjoining lock.

What is claimed:

1. A wrap-around article carrier for carrying articles comprising:
a) a top panel, opposite side panels and a bottom panel;
b) the bottom panel having inner and outer panel flaps, a portion of the outer panel flap overlapping a portion of the inner panel flap;
c) the outer panel flap having at least one secondary male lock formed as an extension of the outer panel flap;
d) the inner panel flap having at least one secondary female opening for each secondary male lock, said opening formed by a slit and interconnecting fold line which forms a female flap in the female opening, said female flap leaning against the secondary male lock when it has been extended through the female opening to assist in holding the secondary male lock in the vertical position in respect to the outer panel flap so the lock does not accidentally become disengaged; and
e) said carrier having a longitudinal dimension running from one bottom panel flap to the opposite bottom panel flap with each secondary male lock and corresponding secondary female opening being aligned along a line traversing the longitudinal dimension of the carrier through the location of at least one article contained therein.

2. The carrier of claim 1, wherein each female flap formed from the secondary female opening has an arcuate tab formed by the slit forming the secondary female opening.

3. The carrier of claim 1, wherein the slit forming the female flap on the secondary female opening is substantially parallel to and closer to the end of the bottom panel flap than the fold line by which the female flap in the female opening is attached to the inner panel bottom flap.

4. The carrier in claim 1, wherein each article being carried has a heel, the carrier further comprising heel retaining assemblies to retain the heels of articles contained.

5. The carrier of claim 4, wherein there are four spaced apart secondary male locks and four spaced apart secondary female openings.

6. The carrier in claim 1, which has means for retaining the tops of the articles being carried from falling out of the ends of the carrier.

7. The carrier of claim 6, in which the means for preventing the articles from falling out of the ends of the carrier comprises:
a) the top panel having two ends with a top end panel attached to each end of the top panel of the carrier;
b) said top end panel being capable of being folded into a closed position on a wrap machine when the top end panel is closed by pressure from a three piece web connected by fold lines, said web interconnected by fold lines to each side panel and adjacent top end panel and consisting of a triangular shaped gusset panel connected by a fold line to a top end panel and in turn connected by a fold line to a triangular shaped web panel which in turn is connected to a tuck-in panel connected by a fold line to an adjacent side panel, said tuck-in panel having a holding tab attached away from the connection to the side panel to hold the top end panel in the closed position.

8. The carrier of claim 7, in which there is an opening between a portion of the side panel and the triangular shaped web panel to facilitate folding the top end panel and web into the closed position.

9. The carrier of claim 8, in which the tuck-in panel is lodged between an adjacent article being carried and the adjacent side wall to assist in holding the adjacent top end panel in the closed position.

10. A bottom panel in an article carrier, said bottom panel being connected to the opposite side walls of the carrier, comprising:
a) inner and outer bottom panel flaps, which are connected to the side walls of the carrier with a portion of the outer bottom panel flap overlapping a portion of the inner bottom panel flap;
b) the outer bottom panel flap having at least one secondary male lock formed as an extension of the flap;
c) the inner bottom panel flap having at least one secondary female opening for each secondary male lock, said opening formed by slit and interconnecting fold line which forms a female flap in the female opening, said female flap leaning against the secondary male lock when it has been extended through the female opening to assist in holding the secondary male lock in the vertical position in respect to the outer flap so the lock does not accidentally become disengaged; and
d) said bottom panel having a longitudinal dimension running from one side wall to the opposite side wall with the secondary male lock and corresponding secondary female opening being aligned along a line traversing the longitudinal dimension of the bottom panel through the center of the location of at least one article located therein.

11. The bottom panel of claim 10 wherein each flap formed from the secondary female opening has an arcuate tab formed by the slit forming the female opening.

12. The bottom panel of claim 10, wherein the slit forming the flap on the secondary female opening is substantially parallel to and closer to the end of the inner bottom flap than the fold line by which the flap in the female opening is connected to the inner bottom flap.

13. The bottom panel of claim 10, wherein there are four spaced apart secondary male locks and four spaced apart secondary female openings.

14. A blank for forming a wrap-around carrier comprising a generally rectangular sheet, said sheet comprising:
a) at one end of the sheet an inner bottom panel flap having at least one secondary female opening for each secondary male lock, said opening formed by a slit and fold line which forms a female flap in the female opening;
b) a side panel, a top panel, and an opposite side panel foldably connected to the inner bottom panel flap in that order;
c) an outer bottom panel flap foldably connected to the opposite side panel, said outer bottom panel flap having at least one secondary male lock formed as an extension of the outer panel flap; and
d) said blank having a longitudinal dimension running from the outer bottom panel flap to the inner bottom panel flap with each secondary male lock and corresponding secondary female opening being aligned along a line traversing the longitudinal dimension of the blank.

15. The blank of claim 14, wherein each female flap formed from a secondary female opening has an arcuate tab formed from a slit forming the female opening.

16. The blank of claim 14, wherein the slit forming the flap on the secondary female opening is substantially parallel to and closer to the end of the inner bottom panel flap than the fold line by which the female flap in the female opening is connected to the inner panel.

17. The blank of claim 14, having a longitudinal dimension running from one inner bottom panel flap to the outer bottom panel flap with each secondary male lock and corresponding secondary female opening being aligned along a line traversing the longitudinal dimension of the blank through the location of at least one article that may be contained therein when the blank is formed into a wrap-around carrier for articles.

18. A wrap-around article carrier loaded with a plurality of articles with flexible walls comprising:
a) a top panel, opposite side panels and a bottom panel;
b) the bottom panel having inner and outer panel flaps, a portion of the outer panel flap overlapping a portion of the inner panel flap;
c) the outer panel flap having at least one secondary male lock formed as an extension of the outer panel flap;
d) the inner panel flap having at least one secondary female opening for each secondary male lock, said opening formed by a slit and interconnecting fold line which forms a female flap in the female opening, said female flap leaning against the secondary male lock when it has been extended through the female opening to assist in holding the secondary male lock in the vertical position in respect to the outer panel flap so the lock does not become accidentally disengaged;
e) said carrier having a longitudinal dimension running from one bottom panel flap to the opposite bottom panel flap with each secondary male lock and corresponding secondary female opening being aligned along a line traversing the longitudinal dimension of the carrier through the location of at least one article contained therein; and
f) the secondary male locks in corresponding secondary female locks being held in the locked position by pressure from the flexible sides of the articles contained therein.

19. The carrier of claim 18, wherein each female flap formed from the secondary female opening has an arcuate tab formed by the slit forming the secondary female opening.

20. The carrier of claim 18, which has means for retaining the tops of the articles being carried from falling out of the ends of the carrier.

21. The carrier of claim 20, in which the means for preventing the articles from falling out of the ends of the carrier comprises:
a) the top panel having two ends with a top end panel attached to each end of the top panel of the carrier;
b) said top end panels being capable of being folded into a closed position on a wrap machine when the top end panel is closed by pressure from a three piece web connected by fold lines, said web interconnected by fold lines to each side panel and adjacent top end panel and consisting of a triangular shaped gusset panel connected by a fold line to a top end panel and in turn connected by a fold line to a triangular shaped web panel which in turn is connected to a tuck-in panel connected by a fold line to an adjacent side panel, said tuck-in panel having a holding tab attached away from the connection to the side panel to hold the top end panel in the closed position.
